(19) United States
(12) Patent Application Publication
(10) Pub. No.: US 2025/0065338 A1
(43) Pub. Date: Feb. 27, 2025

(54) Demounting A High Pressure Grinding Roller

(71) Applicant: Weir Minerals Netherlands B.V., PH Venlo (NL)

(72) Inventors: Sander Artz, ZD Gennep (NL); Dennis Geutjes, BL Velden (NL); Jos Thijssen, DR Tegelen (NL); Bram Steijn, HB Velden (NL); Volodymyr Okorokov, KH Venlo (NL)

(21) Appl. No.: 18/719,673

(22) PCT Filed: Dec. 9, 2022
(86) PCT No.: PCT/IB2022/061984

§ 371 Date: Jun. 13, 2024

(30) Foreign Application Priority Data
Dec. 21, 2021 (GB) 2118704.2

(51) Int. Cl. B02C 4/40; B02C 4/32

(52) U.S. Cl. CPC B02C 4/40; B02C 4/32

(57) ABSTRACT

A frame (12) for demounting a tyre from an HPGR shaft is disclosed. The frame comprises: a support comprising a plurality of structural beams (42a,c,d) adapted to rest on a surface; a registration pin (46) upstanding from the support and dimensioned to be accommodated within a bore defined by the shaft; a tyre support (60) at least partially surrounding the registration pin; and a dampener arrangement (76) mounted on the tyre support and being configured to engage with a lower surface of a tyre to provide balanced support around the circumference thereof, the dampener arrangement including at least one dampener. A method of demounting a tyre from an HPGR shaft is also described.

### FIELD OF INVENTION

This invention relates to a method and apparatus for demounting a high pressure grinding roller (HPGR). More particularly, it relates to demounting a tyre from a shaft of an HPGR roller.

### BACKGROUND OF THE INVENTION

HPGRs comprise a pair of rollers that comminute ore fed into a gap defined between the rollers. Each roller comprises a shaft and a tyre mounted as an interference fit around the shaft. The tyre wears over time and must be replaced. This is typically performed by heating the tyre to expand it, and injecting and pressurising fluid between the tyre and the shaft. One problem with this approach is that due to the close fit of the tyre on the shaft, very large hydraulic forces are needed to remove the tyre therefrom. This can cause the shaft to move upwards in a sudden and unpredictable way, giving rise to safety concerns and potential damage to the shaft. A shaft may typically weigh over fifty tonnes, and the tyre may weigh over forty tonnes. These extremely heavy weights mean that removing a tyre from a shaft is a potentially very hazardous task.

It is among the objects of an embodiment of this invention to obviate or mitigate this problem or provide a useful alternative.

### SUMMARY OF THE INVENTION

This summary is provided to introduce a selection of concepts that are further described in the detailed description below. This summary is not intended to identify indispensable features of the claimed subject matter, nor is it intended for use as an aid in limiting the scope of the claimed subject matter.

In this application relative terms are used, such as front, rear, up, down, etc., only for ease of the description and understanding of the embodiments, not by way of limitation. Ordinal numbers (first, second, third, etc.) are assigned arbitrarily herein, and are used to differentiate between parts, and do not indicate a particular order, sequence or importance.

According to a first aspect there is provided a frame for demounting a tyre from an HPGR shaft, the frame comprising: a support comprising a plurality of structural beams adapted to rest on a surface; a registration pin upstanding from the support and dimensioned to be accommodated within a bore defined by the shaft; a tyre support at least partially surrounding the registration pin; and a dampener arrangement mounted on the tyre support and being configured to engage with a lower surface of a tyre to provide balanced support around the circumference thereof, the dampener arrangement including at least one dampener.

Optionally, the plurality of structural beams are arranged in a cross configuration.

The plurality of structural beams may be provided by a single integral support comprising the plurality of structural beam portions; or a plurality of separate structural beams coupled together.

Optionally, the frame further comprises guides upstanding from the structural beams and spaced from a centre of the registration pin by an amount slightly greater than an external radius of a shaft to be mounted on the registration pin. The guides may include angled surfaces at an upper end thereof, and internal surfaces thereof (that is, those surfaces facing the registration pin) may include a low friction coating or pad coupled thereto.

Optionally, the tyre support extends above the registration pin.

Optionally, the tyre support comprises a plurality of layers of pairs of beams, each pair being mounted on a lower pair at a ninety degree rotation thereto.

Optionally, the dampener arrangement comprises a plurality of dampeners mounted on an upper surface of the tyre support at locations corresponding to circumferentially spaced portions of the lower surface of the tyre to provide a secure, balanced support for the tyre.

Optionally, the dampener arrangement may be mounted on dampener supports fixed to an upper surface of the tyre support.

Optionally, the tyre support extends above the registration pin by a distance that ensures that the dampeners contact, or nearly contact, the lower surface of the tyre when the tyre and shaft combination is mounted on the frame prior to demounting of the tyre.

Optionally, the registration pin extends for at least 10%, 11%, 12%, 13%, 14%, 15%, 16%, 17%, 18%, 19%, 20% or 25% of the length of the shaft.

Optionally, the registration pin has a diameter selected in the range from 130 mm to 300 mm, depending on a diameter of a bore in the shaft.

Optionally, the frame further comprises an annular dampener around the registration pin.

Optionally, the annular dampener comprises a composite of metal layers (for example, metal disks) and elastomer layers (for example, surrounding the metal layers). An alternative elastic support may be used as the annular dampener.

Optionally, the frame includes a platform for retaining a hydraulic pump and conduit through which hydraulic fluid pipes may be routed from the hydraulic pump to the tyre and shaft combination.

According to a second aspect there is provided a method of demounting a tyre from a shaft of an HPGR roller defining a bore in the shaft, the method comprising locating the HPGR roller in an upright orientation; lowering the bore onto a registration pin upstanding from a structural support; injecting hydraulic fluid into passageways between the tyre and the shaft; dampening downward movement of a lower surface of the tyre around the circumference thereof; and raising the shaft from the tyre.

Optionally, the method comprises the further step of orienting a wider section of the shaft at an upper end and a narrower section of the shaft at a lower end, in proximity to the registration pin.

### BRIEF DESCRIPTION OF THE DRAWINGS

These and other aspects of the invention will now be described, by way of example, with reference to the accompanying diagrammatic drawings, in which:

FIG. 1 is a pictorial perspective view of an HPGR roller mounted on a frame according to an embodiment of the invention;

FIG. 2 is a pictorial vertical cross sectional view illustration of the HPGR roller and frame of FIG. 1;

FIG. 3 is a pictorial perspective view of part of the frame (a support and registration pin) of FIG. 1;

FIG. 4 is a pictorial perspective view of the part of the frame shown in FIG. 3 and another part of the frame (a tyre support);

FIG. 5 is a pictorial perspective view of the part of the frame shown in FIG. 4 and another part of the frame (a dampener arrangement);

FIG. 6 is an enlarged view of the HPGR roller mounted on the frame of FIG. 1;

FIG. 7 is a flowchart illustrating the steps involved in demounting a tyre from a shaft of the HPGR roller of FIG. 1;

FIG. 8 is a pictorial perspective view of a lifting coupling attached to one end of a shaft of the HPGR roller of FIG. 1;

FIG. 9 is a pictorial plan view of the HPGR roller of FIG. 1;

FIG. 10 a pictorial plan view of a shaft of the HPGR roller of FIG. 1 once the tyre has been demounted; and

FIG. 11 is a pictorial perspective view of the HPGR roller and frame of FIG. 1 (but rotated by ninety degrees), together with various replacement parts for use with different sizes of HPGR roller.

### DETAILED DESCRIPTION OF EMBODIMENTS

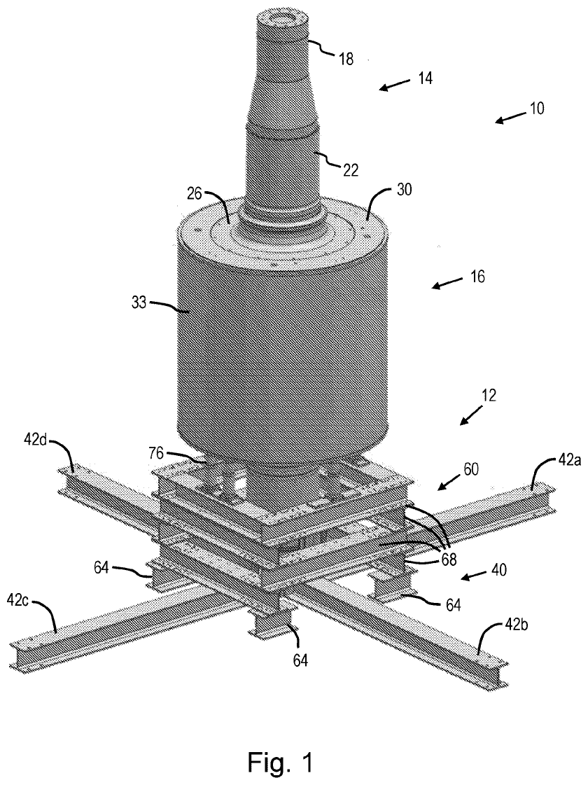

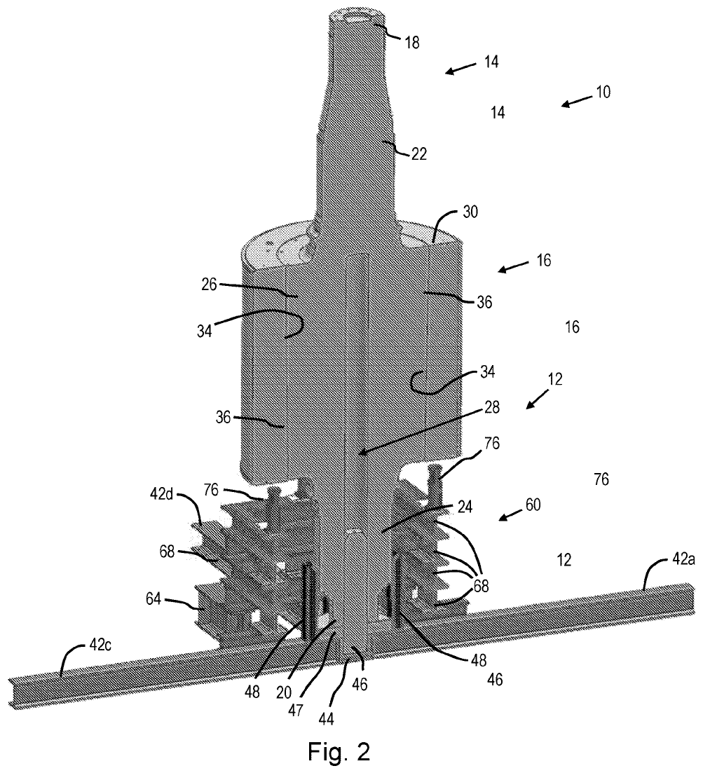

Reference is made to the FIGS. 1 and 2 of the drawings, which illustrate an HPGR roller 10 mounted on a frame 12 in accordance with one embodiment of the present invention. The HPGR roller 10 comprises an elongate shaft 14 onto which a tyre 16 is mounted as an interference fit.

The elongate shaft 14 extends from a driven end 18 to a mounting end 20 and includes a bearing mounting portion 22, 24 near each end 18, 20 and a frusto-conical tyre mounting section 26 located between, and protruding radially from, the bearing mounting portions 22, 24 of the shaft 14. The elongate shaft 14 defines a bore 28 at the mounting end 20. In conventional HPGRs, the bore may be used to cool the elongate shaft 14, so that when the tyre 16 is heated the temperature difference between the shaft 14 and tyre 16 assists with removal of the tyre 16.

The tyre 16 includes an annular portion 30 near the driven end 18 (the upper annular portion), and an annular portion 32 near the mounting end 20 (the lower annular portion).

The frusto-conical tyre mounting section 26 is closer to the mounting end 20 than the driven end 18. Although the frusto-conical tyre mounting section 26 appears to be cylindrical in the drawings, the outer surface is slightly wider at the driven end bearing mounting portion 22 (which is the upper end in FIGS. 1 and 2) than at the mounting end bearing mounting portion 24 (which is the lower end in FIGS. 1 and 2). The angle of the outer surface from the wider end to the narrower end (relative to the axis of the elongate shaft 14) is typically less than four degrees, or less than three degrees. In this embodiment it is slightly less than two degrees.

The tyre 16 defines a cylindrical outer surface 33 and a frusto-conical inner surface 34 that is in close fitting contact with an outer surface 36 of frusto-conical tyre mounting section 26. The frusto-conical inner surface 34 defines a similar angle (approximately two degrees) to the frusto-conical tyre mounting section 26. The wider part of the frusto-conical inner surface 34 of the tyre 16 is located at the wider part of the frusto-conical tyre mounting section 26.

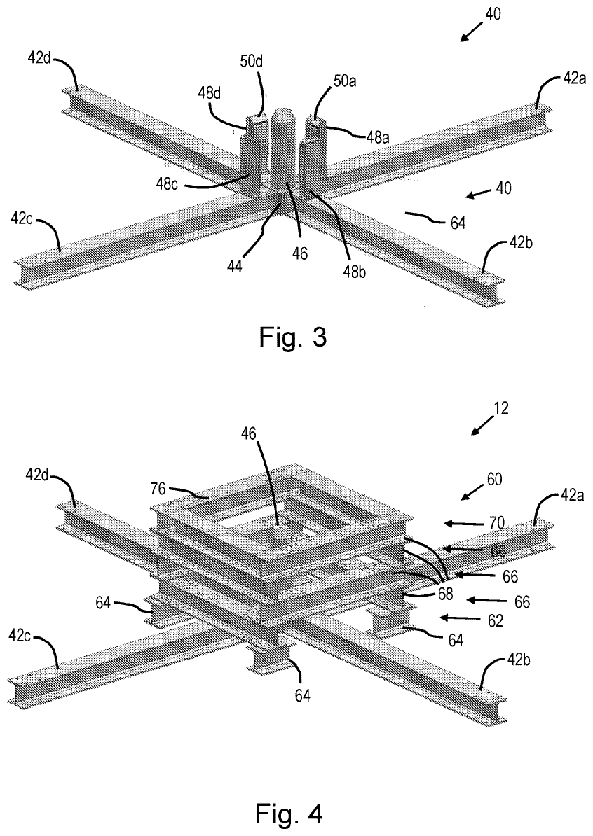

The frame 12 will now be described in more detail with reference to FIGS. 1 to 6, where FIGS. 3 to 5 show different stages of the assembly of the frame 12.

The frame 12 is used to support the HPGR roller 10 while demounting the tyre 16 from the HPGR shaft 14 (and particularly from the frusto-conical tyre mounting section 26 of the shaft 14). The frame 12 comprises: a support 40 comprising a plurality of structural beams 42. In this embodiment, the structural beams 42a,b,c,d are mutually orthogonal and each is coupled to a central support 44 (best seen in FIG. 3) at one end thereof. The support 40 rests on the ground or a structural base. In other embodiments, the structural beams 42 may be cast as an integral unit having a plurality of structural beam portions.

The frame 12 further comprises a central, registration pin 46 upstanding from the central support 44 and being dimensioned to be accommodated within the bore 28 defined by the shaft 14. In this embodiment, the registration pin 46 comprises a generally cylindrical lower and middle body and a tapered upper surface.

In this embodiment, the registration pin 46 extends for approximately 40% of the length of the bore 28, but in other embodiments it may be longer or shorter as desired. The main function of the registration pin 46 is to ensure that the shaft 14 remains in an upright orientation, and as the shaft 14 rises (as described in more detail below), the registration pin 46 should remain within the bore 28 and be able to provide sufficient support to prevent the shaft 14 from moving away from an upright orientation. In one embodiment, the registration pin 46 maintains the shaft 14 in a substantially vertical orientation. In this embodiment, the registration pin 46 has a diameter of approximately 300 mm, which is slightly smaller than the diameter of the bore 28. However, the gap between the outer surface of the registration pin 46 and an inner surface of the bore 28 should not be so great as to allow a large moment of inertia to be created as the shaft 14 deviates from vertical.

As described in more detail below, the shaft 14 will move upwards during removal. To prevent damage to the support 40 (including the central support 44), and also to prevent damage to the shaft 14 when it falls back down on the support 40, an annular dampener 47 is provided around the registration pin 46 (best seen in FIG. 2). The annular dampener is a composite of metal layers (for example, metal disks) and elastomer layers (for example, surrounding the metal layers). This sandwich of metal disks and elastomer dampens the downward movement of the shaft 14, thereby preventing, or at least reducing, any damage to the shaft 14.

The frame 12 also comprises a shaft guide arrangement 48 (best seen in FIG. 3) in the form of four shaft guides 48a to 48d upstanding from the structural beams 42a to 42d and spaced from a centre of the registration pin 46 by an amount slightly greater than an external radius of the shaft 14 at the mounting end 22. In this embodiment, four guides 48a to 48d are used, but in other embodiments a single cylindrical guide may be used, or fewer or greater than four guides may be used. In this embodiment, the shaft guides 48a to 48d are slightly shorter than the registration pin 46, but in other embodiments they may be longer (the upper part being higher) or shorter (the upper part being lower) than the registration pin 46.

The guides 48a to 48d include angled surfaces 50a to 50d respectively (only 50a and 50d are visible in FIG. 3), at the upper, inward-facing, ends thereof, to assist with centring of the shaft 14 as it is lowered onto the registration pin 46. The angled surfaces 50a to 50d and the internal surfaces of the guides 48a to 48d (that is, those surfaces facing the registration pin 46) include a low friction overlay coupled thereto. In other embodiments a low friction coating may be used instead of, or in addition to, the low friction overlay.

The frame 12 also comprises a tyre support 60 at least partially surrounding the registration pin 46. In this embodiment, the tyre support 60 has a generally cuboid shape, and comprises: a lower layer 62 comprising four beam portions 64 (only three of which are visible in the drawings), each located between adjacent structural beams 42; a plurality (two in this embodiment) of intermediate layers 66 of pairs of beams 68, each pair being mounted on a lower pair at a ninety degree rotation thereto, or in the case of the lowest pair, on the set of four beam portions 64; and an upper layer 70 comprising four interconnected beams 68.

In this embodiment, the tyre support 60 extends above the registration pin 46, but in other embodiments this may not be the case. In other embodiments, different designs of tyre support 60 may be used.

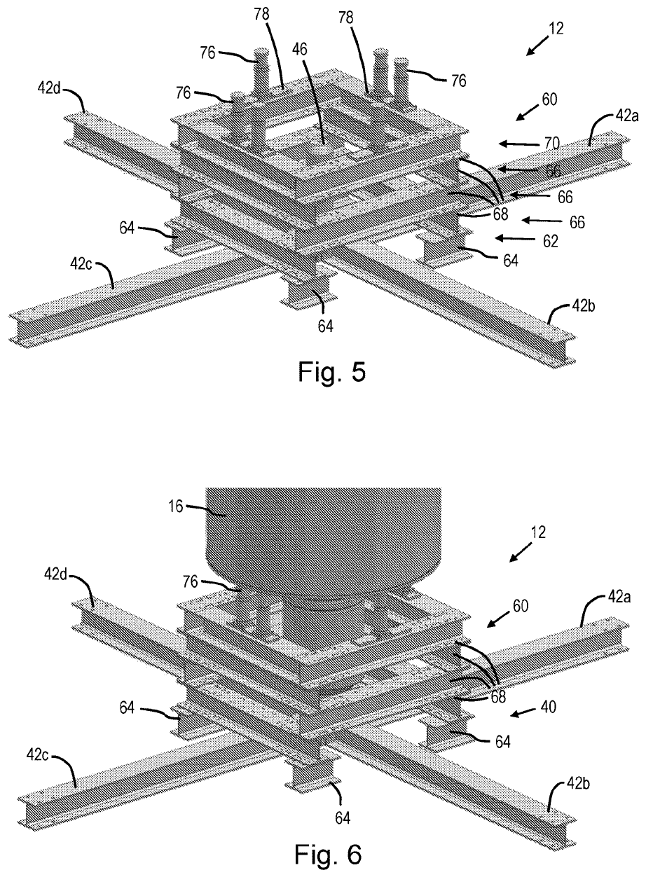

The frame 12 also comprises a dampener arrangement 76 (best seen in FIG. 5) mounted on dampener supports 78 fixed to the upper layer 70 of the tyre support 60. In this embodiment, the dampener arrangement 76 comprises six dampeners 76a to 76f, each mounted on the upper layer 70 at locations corresponding to circumferentially spaced portions of the lower annular portion 32 of the tyre 16 when the shaft 16 is mounted on the frame 12, to provide a secure, balanced support for the tyre 16. In other embodiments, a different dampener arrangement may be used. The number of dampeners used may be selected based on the weight and drop distance of the tyre 16.

In other embodiments, a cylindrical tyre support 60 may be used.

In this embodiment, the dampeners are viscoelastic shock absorbers available from ACE Controls International (https://www.acecontrols.co.uk/) particularly part VS-BA5B-130-FA. In other embodiments, other types of dampeners, such as other types of dampeners that use hydrostatic compression, may be used. Viscoelastic dampeners provide a high damping coefficient, a low sensitivity to temperature changes and increased security by integrated static preload.

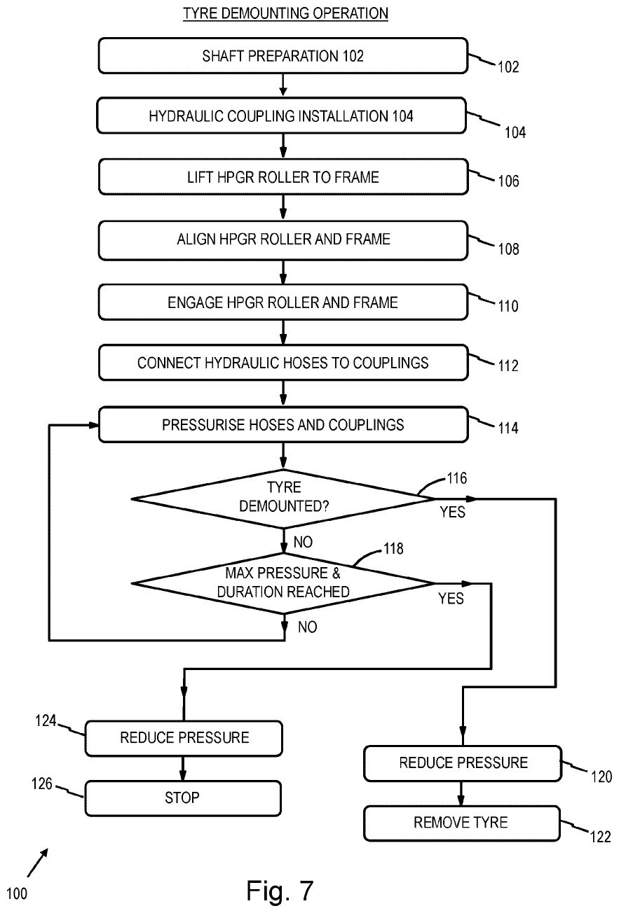

The method of demounting the tyre 16 from the shaft 14 will now be described with reference to the drawings, including FIG. 7, which is a flowchart 100 illustrating the steps involved.

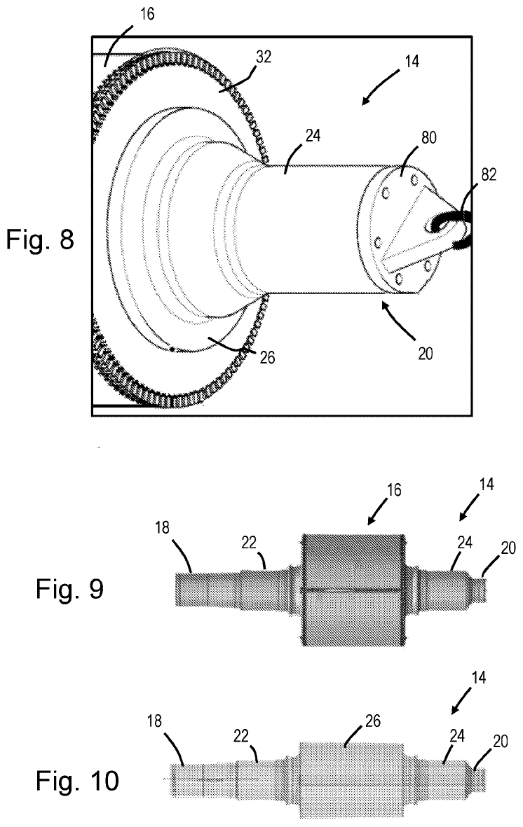

Initially, a shaft preparation step (step 102) is performed in which a flange 80 (FIG. 8) is bolted to each shaft end 18, 20 and a bow shackle 82 (only partly visible in FIG. 8) is coupled to each flange 80 to enable lifting hooks of a double crane or hoist (not shown) to lift the shaft 14 towards the frame 12.

Hydraulic couplings (not shown) are then installed on the tyre 16 in a conventional manner (step 104). The hydraulic couplings are screwed into several fixing points on the tyre 16. Conventional tyres (such as tyre 16) include fixing points (not shown) on the driven end (upper) annular portion 30, and define channels extending from the fixing points to the inner arcuate surface 34 of the tyre 16 in close physical contact with the outer surface 36 of the frusto-conical tyre mounting section 26. These channels allow oil (or other hydraulic fluid) to be pumped therethrough to facilitate separation of the tyre 16 from the frusto-conical tyre mounting section 26.

The double crane (not shown) is then used to lift the HPGR roller 10 into an upright (nearly or completely vertical) orientation (step 106) with the driven end 18 at the top and the mounting end 20 at the bottom.

The HPGR roller 10 is then aligned with the frame (step 108) such that the registration pin 46 and the shaft bore 28 are axially aligned.

The HPGR roller 10 is then engaged with the frame 12 (step 110) by removing the lifting hook from the arm of the double crane supporting the mounting end 20 (the lower end) and lowering the HPGR roller 10 onto the registration pin 46.

Hydraulic hoses are then connected to the hydraulic couplings mounted to the fixing points (step 112) and to a hydraulic pump (not shown), that may be supported on an outer side of the frame 12. The hydraulic hoses and couplings should withstand very high pressures (for example, at least 1500 bar (150 MPa)).

The hydraulic hoses are then pressurized over a period of time (step 114). Initially, the pressure is raised relatively quickly to approximately half of the pressure expected to be needed to separate the tyre 16 from the shaft 14, in this embodiment, the pressure is raised to 700 bar (70 MPa) in approximately 5 minutes. The pressure is then left to stabilize for approximately one hour to ensure that the hydraulic fluid has circulated through the channels extending from the fixing points to an inner arcuate surface of the tyre 16 in close physical contact with an outer surface of the frusto-conical tyre mounting section 26. Provided the pressure is stable, the pressure is then raised in relatively small increments (for example by 50 bar (5 MPa) every five minutes). The hydraulic fluid pressure is allowed to stabilise before any further increase of the pressure. In this embodiment, the maximum pressure used is 1200 bars (120 MPa), which is sustained for no longer than approximately sixty minutes. During this time, an operator (or a sensor arrangement) checks whether the tyre 16 has been demounted (step 116). If the tyre 16 has not been demounted then the pressurisation continues until the maximum pressure and pressure duration has been reached (step 118).

Once the tyre 16 has been demounted, then the pressure is reduced (step 120) and the tyre 16 is removed from the shaft 16 (step 122) for replacement by another (unworn) tyre. FIG. 9 is a pictorial plan view of the HPGR roller 10 prior to removal of the tyre 16, and FIG. 10 a pictorial plan view of the shaft 14 of the HPGR roller 10 after the tyre 16 has been removed.

If the maximum pressure and pressure duration has been reached and the tyre 16 is not dismounted, then the pressure is reduced (step 124) and the tyre 16 removal process is stopped (step 126).

As is known, the use of hydraulic fluid causes the inner tyre surface 34 to separate from the outer surface 36 of the frusto-conical tyre mounting section 26. As the tyre 16 separates from the shaft 14, the slope of the frusto-conical tyre mounting section 26 causes the tyre 16 to drop downwards; however, the dampeners 76 prevent the tyre 16 from falling and absorb the downwards force from the tyre 16. Conversely, the shaft 14 rises upwards (as a reaction to the tyre 16 falling); however, the registration pin 46 (assisted by the shaft guide arrangement 48) maintains the shaft 14 in its upright orientation and prevents it from falling over.

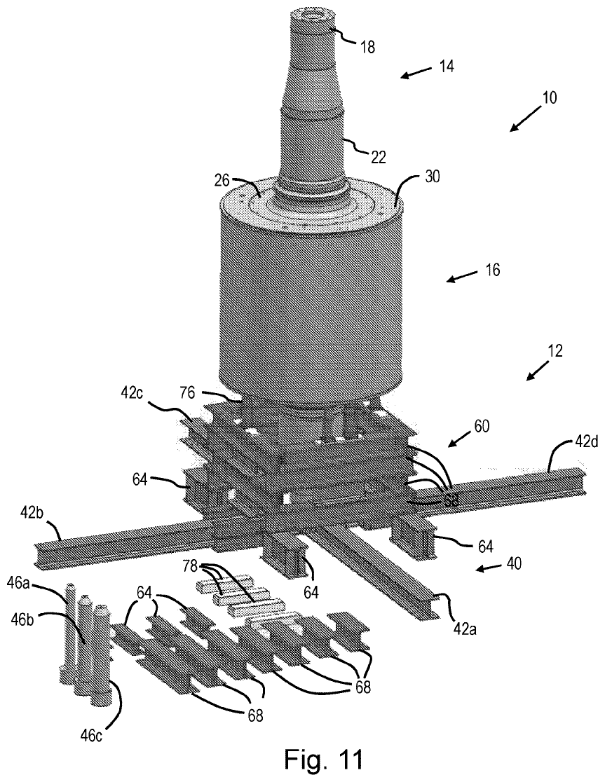

FIG. 11 is a pictorial perspective view of the HPGR roller 10 and frame 12, together with various replacement or expansion parts for use with different sizes of HPGR roller. For example, different sizes of registration pins 46a,b,c are provided for various diameters of shafts, each having a different bore diameter. The required size of registration pin 46 can be coupled to the central support 44. Similarly, additional beam portions 64 and beams 68 are provided to raise the height of the tyre support 60. Additional, or replacement, dampener supports 78 are also provided. Some of these beam portions 64 are placed in the gaps between vertically adjacent beams 68 (as bracing beams) to prevent the upper beam from bending (or being plastically deformed) by the weight of the tyre 16 when it is released from the shaft 14. These additional (bracing) beams are best seen in FIG. 11.

In other embodiments, the tyre mounting section may be cylindrical rather than frusto-conical. In other embodiments, the tyre mounting section may be equidistant between the shaft ends 18, 20. In other embodiments, the inner surface of the tyre 16 may be cylindrical rather than frusto-conical.

The tyre support 60 is provided to give sufficient structural stability to the frame 12 when an HPGR roller 10 is mounted thereon. Other designs of tyre support 60 are therefore possible.

### LIST OF REFERENCE NUMERALS

HPGR roller 10
Frame 12
Elongate shaft 14
Tyre 16
Driven end (of shaft) 18
Mounting end (of shaft) 20
Driven end bearing mounting portion 22
Mounting end bearing mounting portion 24
Frusto-conical tyre mounting section 26
Bore (of shaft) 28
Driven end (upper) annular portion 30
Mounting end (lower) annular portion 32
Cylindrical outer surface (of tyre) 33
Frusto-conical inner surface of tyre 34
Outer surface of frusto-conical tyre mounting section 36
Support 40
Structural beams (of support) 42a, b, c, d
Central support 44
Registration pin 46
Annular dampener 47
Shaft guide arrangement 48
Guide angled surfaces 50a, b, c, d
Tyre support 60
Lower layer (of tyre support) 62
Lower layer beam portions 64
Intermediate layers (of tyre support) 66
Beams (of intermediate or upper tyre support layers) 68
Upper layer (of tyre support) 70
Dampener arrangement 76 (six dampeners 76a to 76f)
Dampener supports 78
Flange 80
Bow shackle 82

1. A frame for demounting a tyre from an HPGR shaft, the frame comprising:
(i) a support comprising a plurality of structural beams adapted to rest on a surface;
(ii) a registration pin upstanding from the support and dimensioned to be accommodated within a bore defined by the shaft;
(iii) a tyre support at least partially surrounding the registration pin; and
(iv) a dampener arrangement mounted on the tyre support and being configured to engage with a lower surface of a tyre to provide balanced support around the circumference thereof, the dampener arrangement including at least one dampener.

2. The frame according to claim 1, further comprising guides upstanding from the structural beams and spaced from a centre of the registration pin by an amount slightly greater than an external radius of a shaft to be mounted on the registration pin.

3. The frame according to claim 2, wherein the guides include angled surfaces at an upper end thereof.

4. The frame according to claim 2, wherein internal surfaces of the guides facing the registration pin include a low friction coating or pad coupled thereto.

5. The frame according to claim 1, wherein the tyre support extends above the registration pin.

6. The frame according to claim 1, wherein the tyre support comprises a plurality of layers of pairs of beams, each pair being mounted on a lower pair at a ninety degree rotation thereto.

7. The frame according to claim 1, wherein the dampener arrangement comprises four dampeners mounted on an upper surface of the tyre support at locations corresponding to circumferentially spaced portions of the lower surface of the tyre to provide a secure, balanced support for the tyre.

8. The frame according to claim 1, wherein the frame further comprises an annular dampener mounted around the registration pin.

9. The frame according to claim 8, wherein the annular dampener comprises a composite of a plurality of metal layers sandwiched between a plurality of elastomer layers.

10. The frame according to claim 1, wherein the frame includes a platform for retaining a hydraulic pump and conduit through which hydraulic fluid pipes may be routed from the hydraulic pump to the tyre and shaft combination.

11. The frame according to claim 1, wherein the plurality of structural beams are arranged in a cross configuration.

12. A method of demounting a tyre from a shaft of an HPGR roller defining a bore in the shaft, the method comprising:
(v) locating the HPGR roller in an upright orientation;
(vi) lowering the bore onto a registration pin upstanding from a structural support;
(vii) injecting hydraulic fluid into passageways between the tyre and the shaft; and
(viii) dampening downward movement of a lower surface of the tyre around the circumference thereof; and raising the shaft from the tyre.

13. The method according to claim 12, the method comprises the further step of orienting a wider section of the shaft at an upper end and a narrower section of the shaft at a lower end, in proximity to the registration pin.
